(19) United States
(12) Patent Application Publication
(10) Pub. No.: US 2014/0016588 A1
(43) Pub. Date: Jan. 16, 2014

(54) Apparatus and Corresponding Method for Allocating a Component Carrier to a Cell in a Communication System

(71) Applicants: Luis Garcia, Belo Horizonte (BR); Istvan Zsolt Kovacs, Aalborg (DK); Klaus Ingemann Pedersen, Aalborg (DK)

(72) Inventors: Luis Garcia, Belo Horizonte (BR); Istvan Zsolt Kovacs, Aalborg (DK); Klaus Ingemann Pedersen, Aalborg (DK)

(73) Assignee: NOKIA SIEMENS NETWORKS OY, Espoo (FI)

(21) Appl. No.: 14/002,380

(22) PCT Filed: Mar. 1, 2011
(86) PCT No.: PCT/EP2011/053018

§ 371 Date: Sep. 25, 2013

(51) Int. Cl. H04W 72/04

(52) U.S. Cl. CPC H04W 72/0453
USPC 370/329

(57) ABSTRACT

A method including determining for a candidate component carrier for a cell if a gain obtained by said cell is better than a loss of a neighbouring cell using said candidate component carrier; and if so, allocating said candidate component carrier to said cell.

Some embodiments of the present invention relate to a method and apparatus and in particular but not exclusively to a method and apparatus in which component carriers may be allocated.

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. For example, it can be defined if carrier aggregation is used. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases. A further development of the LTE is referred to as LTE-Advanced (LTE-A). The LTE-Advanced aims to provide further enhanced services by means of even higher data rates and lower latency with reduced cost. HSPA (high speed packet access) is another example of a communication standard.

LTE-A provides for carrier aggregation, by which two or more component carriers are aggregated in order to support transmission bandwidths wider than that defined by a single component carrier.

It has been proposed to install relatively low-power base stations which may be referred to as “femto-cells” or home evolved node Bs (HeNB). Such low power base stations may be user deployed cellular base stations offering higher capacity for a given area as compared to macro cells. This is because the low power base stations use smaller cell sizes and may have more effective reuse of frequency.

### STATEMENT OF INVENTION

According to one aspect, there is provided a method comprising determining for a candidate component carrier for a cell if a gain obtained by said cell is better than a loss of a neighbouring cell using said candidate component carrier; and if so, allocating said candidate component carrier to said cell.

According to another aspect, there is provided an apparatus comprising at least one processor and at least one memory including computer program code, the at least one memory and computer program code configured to with the at least one processor cause the apparatus at least to: determine for a candidate component carrier for a cell if a gain obtained by said cell is better than a loss of a neighbouring cell using said candidate component carrier; and if so, allocate said candidate component carrier to said cell.

Some embodiments will now be described, by way of example only, with reference to the following examples and accompanying drawings in which:

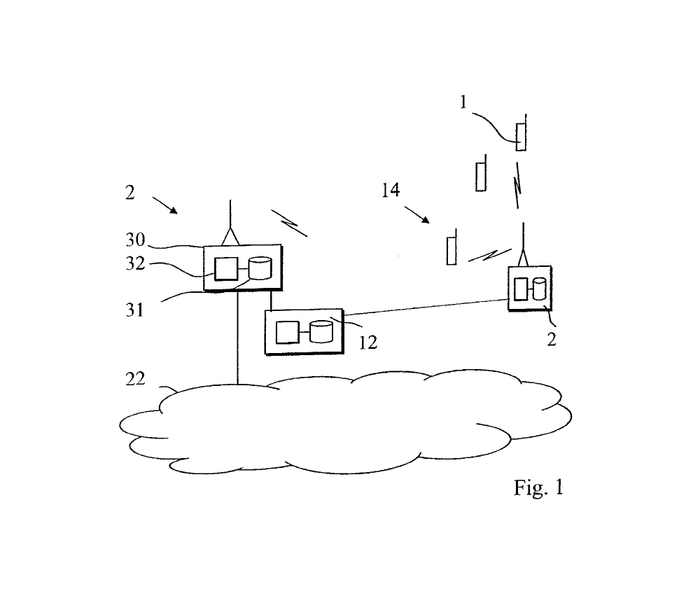

FIG. 1 schematically shows a simplified example of part of a communications network;

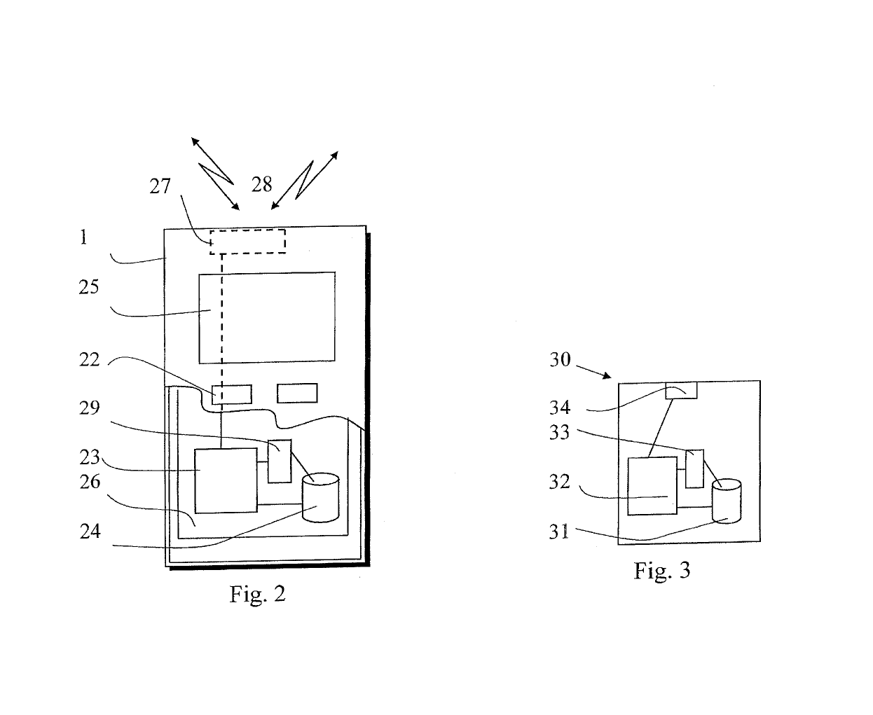

FIG. 2 shows an example of a communication device;

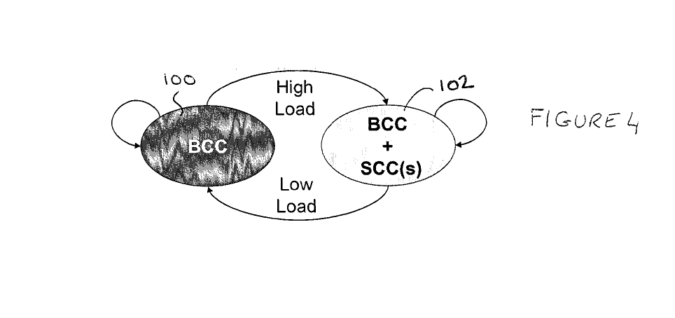

FIG. 3 shows an example of controller apparatus for a base station;

FIG. 4 shows a situation where embodiments may be applied;

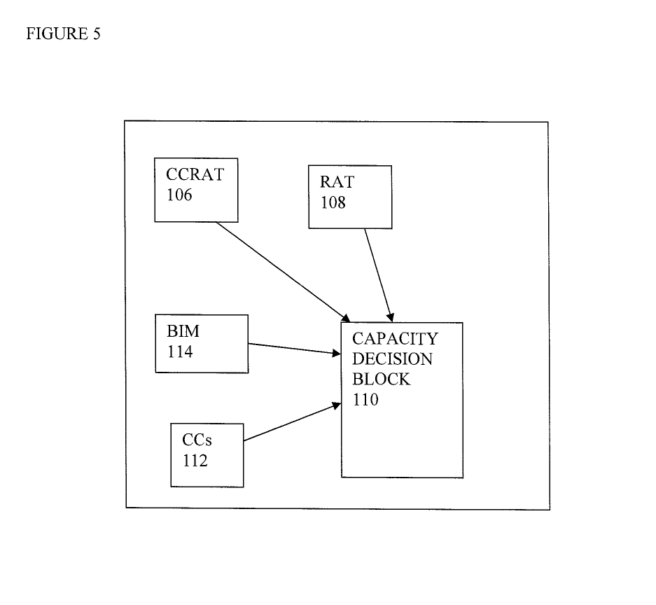

FIG. 5 shows schematically part of an eNB;

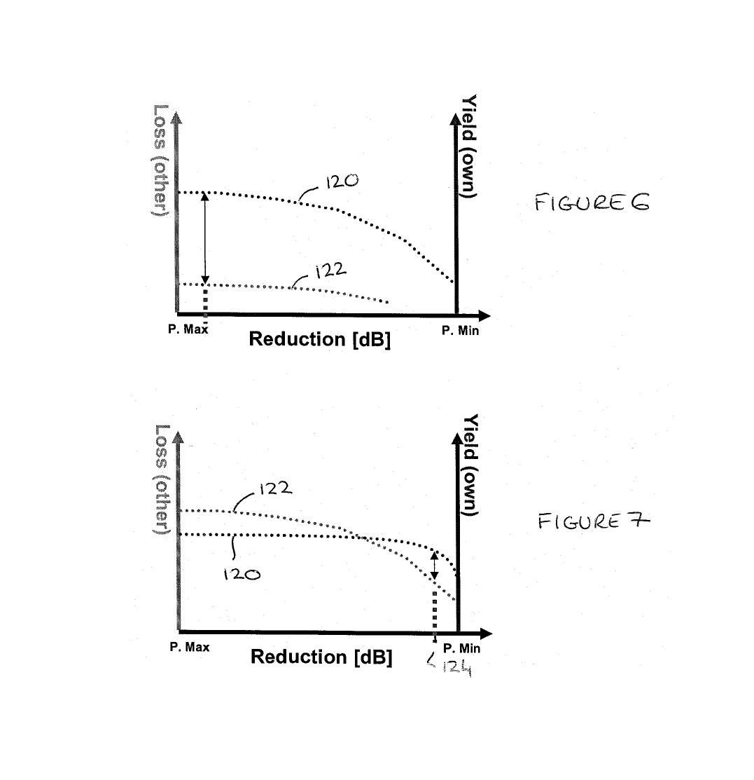

FIGS. 6 to 9 show a graphs of loss and yield versus reduction for a number of different scenarios; and

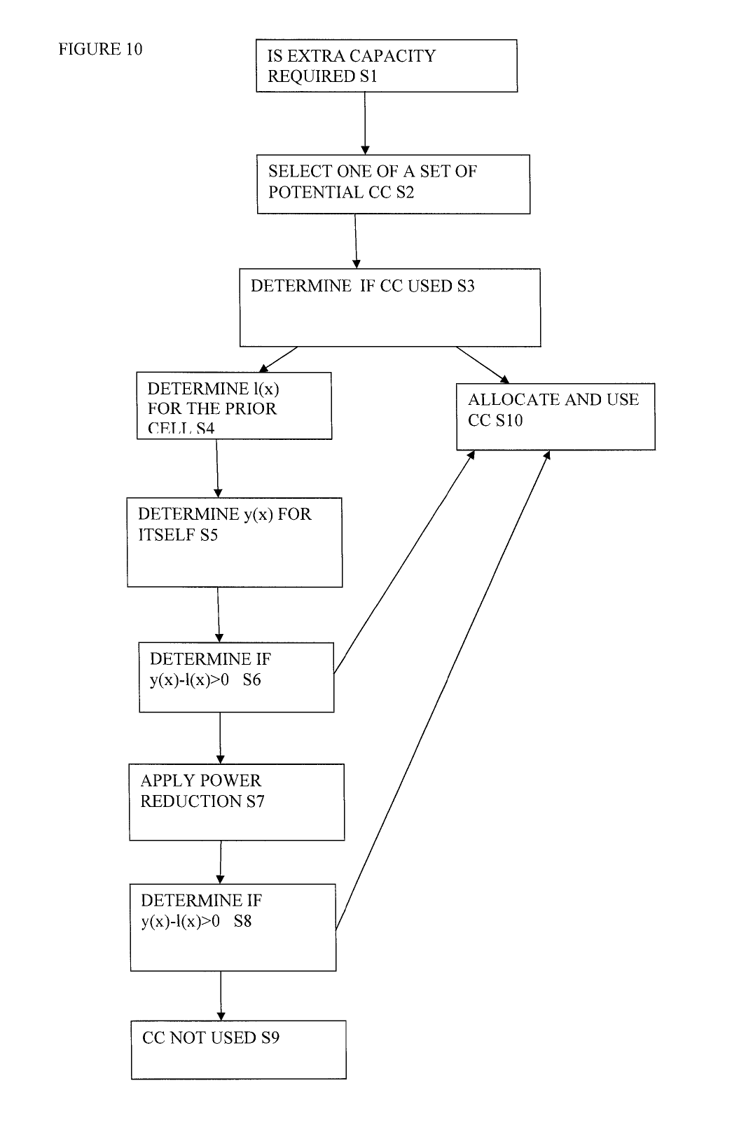

FIG. 10 shows method steps of an embodiment.

In the following certain exemplifying embodiments are explained with reference to wireless or mobile communication systems serving mobile communication devices. Before explaining in detail the certain exemplifying embodiments, certain general principles of a wireless communication system and the nodes thereof are briefly explained with reference to FIGS. 1 to 3 to assist in understanding of the herein described embodiments.

In a mobile system a user can be provided with a mobile communication device 1 that can be used for accessing various services and/or applications. The access can be provided via an access interface between the mobile user device 1 and an appropriate wireless access system, for example an access node. An access node can be provided by a base station. The base stations are HeNB base stations or base stations which serve femto-cells. However, it should be appreciated that the base stations may be base stations which may serve larger cells such as pico or micro cells. Of course, embodiments of the present invention may be used with conventional base stations. It should be appreciated that embodiments of the present invention may be used where there is a mix of different types of base stations serving different types of cells. In some embodiments, the cells served by the femto base stations may be provided at least partially within a larger cell of a macro cell.

FIG. 1 shows part of a radio access network (RAN), including a first base station 2 and a second base station 2. The term base station will be used in the following and is intended to include the use of any of these types of base station mentioned above or any other suitable access node. The base stations each have a cell associated therewith. The cell may be a femto, pico, micro, conventional or any other type of cell. The access system also comprises a mobility management entity (MME) 12. The mobile management entity 12 and the base stations can be connected, for example, by means of a S1 interface.

Although not shown, a gateway function between the access systems, a core network 22 and/or another network such as the packet data network may also be provided by means of appropriate gateway nodes. Regardless of the gateway arrangement, a communication device can be connected to an external data network, for example the internet via the access nodes and the base station.

The mobile communication devices can access the communication system based on various access techniques, such as code division multiple access (CDMA), or wideband CDMA (WCDMA), the latter technique being used by some communication systems based on the third Generation Partnership Project (3GPP) specifications. For LTE (long term evolution) and LTE-A (long term evolution—advanced), OFDMA (Orthogonal Frequency Division Multiplexing) in the DL (down link) and single-carrier FDMA in the UL (uplink) can be used. Other examples include time division multiple access (TDMA), frequency division multiple access (FDMA), space division multiple access (SDMA) and so on.

A non-limiting example of mobile architectures where the herein described principles may be applied is known as the Evolved Universal Terrestrial Radio Access Network (E-UTRAN). Non-limiting examples of appropriate access nodes are a base station of such system, for example what is known as NodeB (NB) or enhanced NodeB (eNB) in the vocabulary of the 3GPP specifications. One example of such an eNB is the home eNB, previously mentioned. Other examples include base stations of systems that are based on technologies such as wireless local area network (WLAN) and/or WiMax (Worldwide Interoperability for Microwave Access). Access nodes can provide cellular system level base stations providing E-UTRAN features such as user plane Radio Link Control/Medium Access Control/Physical layer protocol (RLC/MAC/PHY) and control plane Radio Resource Control (RRC) protocol terminations towards mobile communication devices.

Regardless of the underlying standard, a mobile communication device can be provided wireless access via at least one base station or similar wireless transceiver node of an access system. An access system may be provided by a cell of a cellular system or another radio service area enabling a communication device to access a communication system. Therefore an access system is hereinafter referred to as a radio service area or cell. Typically a cell is provided by a base station site. A base station site can provide a plurality of sectors, for example three radio sectors, each sector providing a cell or a sub radio service area of a cell.

FIG. 2 shows a schematic, partially sectioned view of a communication device 1 that a user can use for communication. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

The mobile communication device 1 may receive and transmit signals over an air interface 28 via appropriate apparatus for receiving and transmitting signals. In FIG. 2 transceiver apparatus is designated schematically by block 27. The transceiver may be provided for example by means of a radio part and associated antenna arrangement. The antenna arrangement may be arranged internally or externally to the mobile device.

A mobile communication device is also typically provided with at least one data processing entity 23, at least one memory 24 and other possible components 29 for use in software and hardware aided execution of tasks it is designed to perform, including control of access to and communications with base stations and other communication devices. The data processing, storage and other relevant control apparatus can be provided on an appropriate circuit board and/or in chipsets. This feature is denoted by reference 26. Possible control functions in view of configuring the mobile communication device for reception and/or transmission of signalling information and data by means of the data processing facility in accordance with certain embodiments of the present invention will be described later in this description.

The user may control the operation of a communication device by means of a suitable user interface such as keypad 22, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

FIG. 3 shows an example of a control apparatus 30, for example to be coupled to a base station and/or part of the base station itself. The control apparatus 30 can be arranged to provide control on use of resources for communications by mobile communication devices that are in the service area. The control apparatus 30 can be configured to provide control functions in association with generation and communication of resource allocation information and other related information and for coordination of resource allocation for signalling and data communications by means of the data processing facility in accordance with certain embodiments described below. For this purpose the control apparatus 30 comprises at least one memory 31, at least one data processing unit 32, 33 and an input/output interface 34. Via the interface the control apparatus can be coupled to receiver and transmitter apparatus of a base station. The control apparatus 30 can be configured to execute an appropriate software code to provide the control functions.

As mentioned previously, LTE-A is being proposed in the 3GPP context. Such a system has carrier aggregation (CA) and supports heterogeneous networks (HetNet). A heterogeneous network has a conventional cellular network which may be overlaid with one or more micro, pico and/or femto cells. The femto cells may be home femto cells which may be subject to unplanned deployment. Efficient interference management schemes are therefore desirable for the optimisation of HetNet cases. One of the proposed interference management schemes for LTE-A uses carrier aggregation and is called autonomous component carrier selection (ACCS).

The ACCS scheme provides an automatic and distributed mechanism for dynamic frequency reuse of component carriers (CC). In the ACCS concept, there is the initial selection of a cell specific component carrier. This initial selection of the cell's specific component carrier is the main component carrier to be used by the base station which has full cell coverage regardless of the served user equipment's capability. This main component carrier has been previously referred to as the primary component carrier. In this document, we will call this main component carrier the base component carrier (BCC). This base component carrier is the component carrier which is the one which is always available to the base station. Any additional (that is additional to the BCC) component carriers available for the base station and user equipment to access will be called the supplementary component carriers (SCC). These SCCs are cell specific. In some situations, these supplementary component carriers are sometimes referred to as secondary component carriers.

The ACCS concept also relies on the collection of a background interference matrix (BIM) at each base station. The BIM is used by the base stations to determine if that base station is allowed to take additional component characters into use without experiencing or causing excessively low signal to interference plus noise ratio (SINR) in the evaluating base station as well as any surrounding cells using the same component carrier.

Each cell (eNB or base station) maintains information on all the potential interfering cells and a corresponding conditional C/I (carrier to interference ratio) value, the incoming BIM. The C/I value is a measure of mutual interference coupling between a pair of cells which use the same CC simultaneously. This value is estimated as follows. For each active UE connected to the cell, RSRP (reference signal received power) measurements are reported for both the serving cell and the surrounding cells. The conditional C/I, describe the RSRP difference between the serving cell and the surrounding cells. Based on the RSRP measurements reported from the different UEs, an empirical C/I distribution can be defined locally within each eNB. The C/I value stored in the BIM for each surrounding cell is the value corresponding to a certain outage of e.g. 90%. The values in the locally stored BIM can be updated either periodically or event based. Of course the method and/or information stored in the BIM may be different in alternative embodiments.

This autonomous component carrier selection scheme provides an automatic and fully distributed mechanism for dynamic frequency reuse on a component carrier resolution for LTE-A. In principle, each component carrier is eligible for a use in any cell provided that certain SINR constraints are satisfied. However, as initially proposed, such SINR constraints have been recognised by the inventors as acting an overprotective limitation. The inventors have noted that in the current ACCS proposal the incoming interference estimations are considered to be as critical as the outgoing ones during the decision process. In contrast, the inventors have recognised that from a cell centric perspective, more bandwidth is generally not harmful to the particular cell regardless of how low the expected SINR is.

Furthermore, the currently proposed ACCS scheme to the extent that power domain optimisation is done, takes place in a reactive manner by means of interference reduction requests.

In a typically dense urban environment, the deployment of HeNBs may be with a relatively high density. This means that the number of cells competing for additional resources may be much larger than the total number of component carriers. Typically, the number of available component characters may be between 3 and 5. Of course in different embodiments, more or less than this number of component carriers may be available.

This will mean that some cells are unfavourably treated and become bandwidth limited. Such cells may be left with nothing but their base component carriers due to the potentially overprotective minimum SINR constraints the cells are required to adhere to during SCC selection. Thus, with current proposals, the number of SCCs allocated to each cell at any given moment is highly dependent on the order in which the cells attempt the allocation of extra component carriers. This easily leads to situations where there are severe inequities or the pre-emption of component carriers as there are no guarantees that a cell will still be granted access to supplementary component carriers after critical neighbours have made their choices.

In embodiments, more emphasis is put on controlling interference generated towards neighbouring cells, that is outgoing interference rather than evaluating the potential interference received from other cells, i.e. incoming interference. In embodiments, the ideal power spectral density (PSD) of each component carrier is estimated before attempting any allocations. This is to make component carrier reuse as frequent as possible. Embodiments attempt to render the distribution of SCC less sensitive to the temporal evolution of the bandwidth acquisition/waiver process.

It has been appreciated that in practical situations, not all HeNBs need additional component carriers at all times. The base component carrier may be sufficient for the HeNB for at least some of the time. This may for example be due to long term traffic demand patterns, for example, time of day dependent traffic. For example it is not unusual for an HeNB to have little or no traffic during the day but to have much heavier traffic in the evening.

Some embodiments build on the ACCS concept and extend that concept to deal with time domain related aspects of component carrier selection, such as bursty data and for example time dependent traffic use patterns.

In some embodiments, the potential secondary component carrier starvation problem which has been outlined above can be reduced or avoided without the need for additional parameters or inter eNB signalling. In embodiments this may be achieved by setting the maximum PSD used per component carrier in the downlink.

It should be appreciated that whilst embodiments will be described primarily in relation to the downlink situation, the same scheme can also be employed for uplink communications.

In summary, embodiments use the information found in the BIM proactively to set the PSD of a desired component carrier in order to provide a balance between the minimisation of the outgoing interference and the usefulness of a given component carrier.

In some embodiments, no additional signalling is required.

Embodiments may identify an ideal transmit power per CC.

In embodiments, the CC starvation problem is addressed by providing a mechanism which controls the way in which cells attempt to use component carriers that have been taken earlier by some other cell. Embodiments retain the first-come first choice service policy of ACCS but allow cells selecting their component carriers later on to try and allocate new component carriers provided that the cells reduce their power spectral density in order to minimise the outgoing interference towards the cell currently holding that component carrier. The cell which currently holds a particular component carrier is referred to as a prior cell. The cell which is trying to also use that component carrier is referred to as a posterior cell. It should be appreciated that one cell e.g. A can be regarded as a prior by some other cell e.g. B when B is trying to allocate a certain CC. Afterwards, if a third cell C attempts to allocate the same CC, cell B will be treated as a prior cell by cell C.

Embodiments aim to try and maximise the capacity of both the posterior and prior cells under two restrictions. Firstly, prior cells have higher priority and should not incur capacity losses larger than the potential capacity gain obtained by a posterior cell. Secondly, the prior cell does not have any power reduction. Rather, any power reduction required is only performed by the posterior cells. Thus, the PSD of the prior cells remain unchanged and the posterior cells are aware of this.

In embodiments, these two restrictions are used in which the ideal PSD is calculated by a given posterior cell during the component carrier allocation attempt.

It should be appreciated that embodiments are used for the acquiring of supplementary component carriers or additional component carriers. However, some embodiments may potentially also be used in the selection of the base component carrier. The same method may therefore be used to reselect the BCC yielding a combination of maximum (own) benefit and minimal loss (other). However, in the LTE-A femto-femto context, the BCC may have a higher priority and may not allow PSD reductions if femto cells are assumed to have equal rights. In a femto/macro context, even the BCC could be powered down assuming the macro cell is dominant.

If the capacity loss of the prior cell is negligible, the posterior cell will allocate the component carrier and set the PSD appropriately. This will be regardless of the capacity yield of the posterior cell. This generally assumes that the capacity yield is not zero.

If, on the other hand, the capacity loss of the prior cell is considered to be critical, the posterior cell will not allocate the component carrier to that posterior cell. This is regardless of the capacity yield of the posterior cell. This is on the basis that if the prior cell has very little or nothing to lose, the posterior cells should allocate the CC, even if the yield to the posterior cell is low due to incoming interference. Conversely, if the prior cell is estimated to experience a critical capacity loss due to outgoing interference, the posterior cell refrains from allocating the component carrier irrespective of the potential capacity gain to the posterior cell.

In some embodiments, the critical or negligible capacity losses may be defined by thresholds. These thresholds may be defined in any suitable manner and some examples will be given later.

ACCS does not deal with traffic requirements and fairness governing the acquisition or release of SCCs. Such requests may come from lower radio resource management RRM layers. For example, the BCC may service a HeNB serving only low bit rate VoIP (voice over IP) users where low latency is much more relevant that high throughput. The number of component carriers required by each cell may depend on the traffic profile of that particular cell. Generally, heavily loaded cells may need supplementary component carriers much more often than lightly loaded ones in order to best serve its users.

In this regard, reference is made to FIG. 4 which schematically illustrates embodiments. In the arrangement of FIG. 4, two states of a HeNB cell are shown, 100 and 102. State 100 is a relatively low traffic state and accordingly is served by the BCC alone. In contrast, the second state 102 has a relatively high load and is served by the BCC and one or more SCCs. When the cell is in the low traffic state 100 and then acquires more traffic, then the state will change to the second state and vice versa.

As with an ACCS, the component carrier allocation of neighbouring cells is stored locally by each eNodeB in the so-called component carrier radio allocation table (CCRAT). In this regard, reference is made to FIG. 5 which shows in more detail a schematic arrangement of a part of the eNodeB. The CCRAT table is referenced 106 and the BIM table is referenced 114. Thus, each eNodeB will broadcast its own radio resource allocation table RRAT over a specified low capacity signalling channel which may be wired or wireless. This RRAT may include the selection of the CCs, respective power reductions and/or the use of the CC, i.e. whether or not the CC is a base CC or a supplementary CC. The RRAT table is schematically shown in FIG. 5 and is referenced 108. It should be appreciated that in one embodiment, the RRAT and the CCRAT may be combined in a single table which includes information indicating the respective eNodeB to which the information applies. In one embodiment, not all of the information contained in the RRAT is provided to the neighbouring eNodeBs but only some of the information is provided.

The eNodeB of FIG. 5 has a capacity decision block 110 which is configured to determine if the eNodeB requires one or more additional component carriers. The capacity decision block 110 will take the one or more additional component carriers into use without further consideration if, and only if, the desired component carrier or component carriers are not used by any of its neighbouring cells. The capacity decision block 110 will be able to make this decision based on the information contained in the CCRAT table 106. In one embodiment, the capacity decision block 110 will use information stored in a component carrier table 112. The component carrier table 112 will indicate the entire set of possible component carriers which could be used by the eNodeB.

Thus, if the capacity decision block 110 notes that the additional component carrier or carriers are not used by any of its neighbouring cells, the eNodeB will take those additional component carrier or carriers into use. This retains the first-come first choice service policy of ACCS.

In one embodiment, once the additional component carrier or carriers have been granted to a cell, this cell will have a higher priority over those component carrier or component carriers until the cell releases those component carriers due for example to a load reduction in that cell. Thus, in some embodiments, the capacity decision block 110 will be configured to monitor the capacity requirements and when the capacity requirements fall, release one or more of the component carriers if those component carriers are no longer required.

When a cell attempts the allocation of a component carrier that is already taken by a prior cell, that cell takes the role of the posterior cell. This mean that the capacity decision block 110 must first evaluate the trade off between its potential capacity gains and the potential damage or capacity loss caused to the prior cell and set its PSD accordingly.

Some embodiments use one or more of the following metrics:
loss—incurred by the prior cell due to the new allocation of that same component carrier to the posterior cell; and
yield—the potential capacity gain obtained by the posterior cell.

The loss metric can be evaluated by the following equation:

l(x)=C_{free}−C(Ω+x) (1)

The yield can be evaluated by the following equation:

y(x)=C(t−x) (2)

l is loss, y is yield, and x is an independent variable and is the power reduction to be applied only by the posterior cell. C is the capacity estimation. The capacity estimation C(·) relies on the BIM information which is stored in the BIM table 114 and a priori characterisation of the performance of the system. In fact, C_{free} roughly corresponds to the status of the prior cell before the posterior cell puts the CC into use. The BIM value in (1) simple contains the expected C/I experienced at the prior cell caused by the posterior cell allocating the CC.

The C/I values found in the BIM from/towards neighboring cells are input to a Shannon-like formula adjusted to reflect the link level performance of an LTE system as a function of SINR.

This is one example of such an equation:

S (bits/s/Hz)=BW_eff·|η·log₂ (1+SNR/SNR_eff)

Where BW_eff adjusts for the bandwidth efficiency and SNR_eff adjusts for the SNR implementation efficiency. S is the spectral efficiency and ·η is a physical system parameter.

This is one example. It should be appreciated that any other method or equation can be used to determine the spectral efficiency. Generally there is a mapping, adjusted to the characteristics of the system considered. In the LTE example, this is a carrier/interference ratio to spectral efficiency (bit/second/Hertz). In the previous formulation interference is treated as noise, but there can be situations where this is not the case.

In a basic implementation, the free capacity C_{free} could correspond to the maximum throughput achievable by the system without any interference. In other words, the bandwidth of the carrier component is absolutely free for the cells to use with the highest modulation and coding scheme (MCS) available. Alternatively, C_{free} could correspond to an estimation based on the experienced SINR or alternatively the actual SINR value. This is SINRvalue experienced by the prior cell in Equation 1 and the posterior cell in equation 2. The latter two alternatives are advantageous in some situations in that the information in that C_{free} can be more accurately determined. However, this is offset in that additional signaling in order to inform the posterior cell about the conditions in the prior cell may be required. Thus, in some embodiments, the approach of assuming that C_{free} corresponds to the maximum throughput achievable by the system regarding interference may be used.

Ω corresponds to the conditional outgoing carrier to interference ratio taken from the BIM towards the prior cell with the lowest effective outgoing BIM (after any potential PSD reduction already in place as indicated in the CRRAT are taken into account) carrier to interference ratio entry amongst all those currently using the desired component carrier as seen in the CCRAT table. In other words, the SINR experienced in the most affected prior cell in the case that the posterior cell uses the component carrier as well. In equation 2, l denotes the conditional incoming carrier to interference ratio taken from the BIM for the cell causing the lowest effective incoming BIM (after any potential PSD reduction already in place as indicated in the CRRAT are taken into account) carrier to interference ratio entry amongst all those currently using the desired component carrier as seen in the CCRAT table. It should be appreciated that such a cell is not necessarily the prior cell considered in equation 1 given a possible asymmetry of the interference coupling. For example, in a scenario with randomly located user equipment and HeNBs, cell A may be a strong interferer to cell B and may be critically interfered by C, while B and C do not interfere with each other and the interference A receives from B is very low.

The component carrier would be deployed by the posterior cell using the PSD reduction given \hat{x} such that

$$\hat{x} = {argmax}_{x ∈ [ 0 , p ]} y ( x ) - l ( x ) ∋ y ( x ) - l ( x ) > 0 , \qquad ( 3 )$$

In equation 3, p denotes the maximum power reduction possible in order to use transmit power levels which still remain above or equal to the minimum nominal transmission value. X is the optimization parameter and it is set such that for values of x between 0 and p, the maximum of yield minus the loss must be greater than 0. Thus, the posterior cell allocates the desired CC with a PSD reduction. (\hat{x}) that (i) maximizes the benefit of the posterior cell and (ii) minimizes the loss of the prior one while (iii) ensuring that the yield is strictly larger than the loss. A larger safety margin can be introduced by requiring the difference between the yield minus the loss to be some value which is larger than 0.

One advantage of some embodiments is the lack of a fixed threshold. There may be no fixed thresholds to which capacity or SINR values are compared against. The restriction, in one embodiment, of being larger than zero is part of the framework and may ensure minimal perturbation to the prior cells. Some embodiments may use the principle that it would be unfair and potentially inefficient to allow the usage of one CC in one cell simply because it benefits from it irrespective of the losses it causes to a neighbor already using it.

Equation 3 sets the power reduction such that the distance the yield and loss curve is maximized. Reference is made to FIG. 6 which shows a graph where the curve referenced 120 represents the yield and the curve referenced 122 represents the loss. Loss and Yield are respectively shown on the y axes and the power reduction of the CC in the posterior cell is shown on the x axis. Pmax is the maximum power which could be used for the CC in the posterior cell. Pmin represents the minimum power which could be used for the CC in the posterior cell. In the arrangement shown in FIG. 6, only a soft reduction in the maximum power possible may be used since the allocation of the component carrier by the posterior cell has little impact on the prior cell. In other words, the yield minus the loss is very much greater than 0. In some embodiments only a soft reduction is used to minimize the loss as much as possible no matter how small it may be.

Reference is now made to FIG. 7 shows again a graph of the loss versus the power reduction on one hand versus yield and power reduction on the other hand. The loss curve is again referenced 122 and the yield curve is referenced 120. At the maximum power, the loss is much greater than the yield and accordingly, allocation will only be allowed if an aggressive power reduction is applied to the desired carrier component minimizing the loss incurred by the prior cell. The posterior cell has little incoming interference coupling with the prior cell and the power reduction will have little impact on the yield. As can be seen, when the power is near the minimum (but higher than the minimum) as indicated at a position referenced 124, the yield will be greater than the loss and as such the allocation will be allowed. However, without this reduction in the power, the carrier component will not be allocated to the posterior cell.

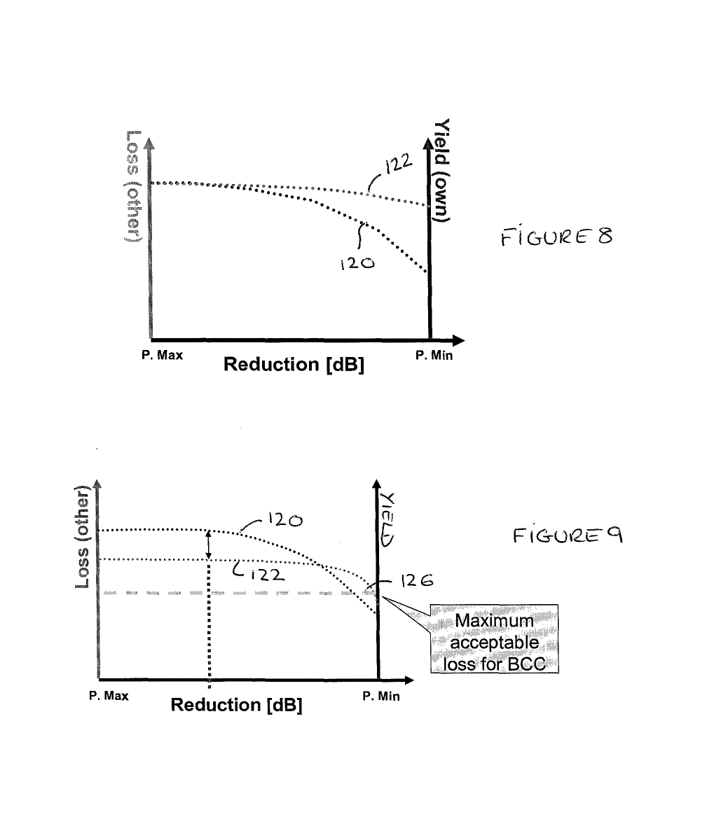

Reference is made to FIG. 8 which shows a further example. In this case, again the loss curve is referenced 122 and the yield curve is referenced 120. This case illustrates an example where allocation is not performed since the loss is never smaller than the gain, even at the minimum power. Reducing the transmission power lowers the loss marginally and decreases the yield significantly.

Reference is made to FIG. 9 which again shows a graph of loss versus reduction on the one hand and yield versus reduction on the other hand. Again, the yield curve is referenced 120 whilst the loss curve is referenced 122. The only difference between a BCC and a SCC is the fact that a cell is always the prior cell when it comes to its own BCC since it is never relinquished. However, in one embodiment, if additional protection or differentiation is required, a maximum loss allowed for a BCC in the prior cell may be provided. A maximum loss threshold acceptable for the BCC is shown in FIG. 9 and is referenced 126. This maximum acceptable loss for the BCC can offer additional protection for the BCCs when other cells attempt to use that BCC as a SCC. As can be seen in FIG. 9, even though there is a region where the yield is greater than the loss, in this region the loss is above the maximum acceptable loss threshold. Therefore the posterior cell would not be able to allocate the CC. When the loss is finally below the maximum allowed loss, the yield is no longer greater than the loss. However, even when the loss falls below the maximum acceptable loss for the BCC, the yield is no longer greater than the loss and again the attempt to allocate the CC fails. In summary if the loss is above the maximum loss, reject the allocation. If the loss is below the maximum loss, then allocation may take place.

In some embodiments, cross-checking by the prior cell is possible provided that the outgoing interference coupling with the prior cell is the most restrictive incoming interference coupling as perceived by the posterior cell. More complicated cross-checking can be required other than in these circumstances and requires additional information such as the carrier to interference value used in equation 2 by the posterior cell. For example the prior cell can check that the posterior cell did not “cheat”.

Reference is made to FIG. 10 which schematically shows a method of an embodiment. In step S1, the eNodeB makes a determination as to whether extra capacity is required.

In step S2, if it is determined that extra capacity is required, the eNodeB selects one of a set of potential carrier components.

In step S3, the eNodeB determines if the carrier component is used. It should be appreciated that in some embodiments, in step S2, the eNodeB will use the following parameters for selecting a component carrier: the eNodeB will first select a component carrier which is unused. If such component carrier is not available, then the eNodeB will select a component carrier from a cell which is considered to provide the least interference to the current cell. Of course in alternative embodiments, the eNodeB may have a predefined order in which it selects the component carriers or may use any other suitable way to select the component carrier. Accordingly, in some embodiments steps S2 and S3 may be part of a single step.

If it is determined that the component carrier is not used by the relevant surrounding cells, the next step is S10 where the component carrier is allocated and used.

If it is determined that the component carrier is used by a relevant neighboring cell, the next step is step S4 where the eNodeB is arranged to determine l(x) for the prior cell i.e. the cell using the selected component carrier.

In step S5, the eNodeB is arranged to determine the yield y(x) for itself.

This is followed by step S6 where it is determined whether the yield y(x) minus the loss l(x) is greater than 0. It should be appreciated that steps S4 and S5 may take place at the same time or in the opposite order to that shown in FIG. 10. In some embodiments, steps S4, S5 and S6 may take place in a single process.

If it is determined in step S6 that the yield less the loss is greater than 0, then the next step is S10 where the CC is allocated and used.

If it is determined that the yield minus the loss is not greater than 0, then the next step is S7 where a reduction is applied, as for example illustrated in relation to FIGS. 6 to 9. This may be a maximum power reduction or the power may be iteratively reduced until either the power is at a minimum or the yield is greater than the loss.

This effectively means that the transmit power level which will be used by the posterior eNodeB for the new CC is reduced. This generally has the function of reducing the loss suffered by the prior cell. The yield may at the same time be reduced but generally the reduction in the yield will be less than the reduction in the loss.

After the maximum power reduction has been applied, the next step is step S8 where it is again checked to see whether or not the yield is less than the loss. In practice, S8 may include carrying out the determinations carried in steps S4, S5 and S6 again but with the reduced transmit power. As mentioned, the relevant steps may be iteratively performed.

If it is determined that the yield minus the loss is now greater than 0, then the next step is step S10 where the component carrier is allocated and used.

If, on the other hand, it is not determined that y(x) minus l(x) is not greater than 0, then that component carrier is not used.

The process of FIG. 10 may be repeated with different component carriers. This process may be repeated until the eNodeB has a suitable additional component carrier.

In some embodiment, a base station will not transmit with power p while it is being evaluated. It may simply be an internal optimization. Once a value is found the allowed CC(s) are deployed with the calculated powers/CC.

The goal may not just to find out if y(x)−l(x)>0. For example the search may be after (\hat{x}) that maximizes this difference. So if a valid (\hat{x}) exists, the CC should be deployed with that power reduction.

In one modification of steps 2 and 3, in principle, any CC where there exists a valid (\hat{x}) can be considered a CC to be deployed. The node could for e.g. consider deploying all of them or if fewer are required, the ones in descending order of yield (\hat{x}).

It should be appreciated that the method of claim 10 may be performed using the capacity decision block 110 shown in FIG. 5. The capacity decision block may be at least partially implemented by one or more processers. It should be appreciated that the blocks storing the CCRAT, the RRAT, the BIM and the CCs may be provided by one or more memories. Aspects of two or more of these blocks may of course be consolidated into a single memory table. The information may be stored in alternative forms to the memory table.

In an alternative embodiment, the relative capacity gain of the posterior cell with respect to its capacity just before the component carrier is deployed can be compared to the relative capacity loss of the prior cell after the posterior cell deploys the common component carrier with respect to the prior cell capacity before the deployment.

Of course other measures of the prior cell loss versus the posterior cell gain may be used in embodiments of the invention.

It should be appreciated that at least some of the method steps may be implemented by one or more computer programs. Such computer program(s) may comprise one or more computer instructions which when run on one or more processors cause the associated method step to be performed.

Whilst embodiments of the present invention have been described in relation to the LTE it should be appreciated that embodiments of the present invention can be used in conjunction with any other suitable standard.

It is noted that whilst embodiments may have been described in relation to user equipment or mobile devices such as mobile terminals, embodiments of the present invention may be applicable to any other suitable type of apparatus suitable for communication via access systems. A mobile device may be configured to enable use of different access technologies, for example, based on an appropriate multi-radio implementation.

Reference has been made to a home eNodeB. It should be appreciated, that embodiments may be implemented in any other suitable base station or radio access node. In some embodiments, one or more of the method steps may be performed in a control node which may be associated with the base station or separate therefrom.

It is also noted that although certain embodiments may have been described above by way of example with reference to the exemplifying architectures of certain mobile networks, embodiments may be applied to any other suitable forms of communication systems than those illustrated and described herein. It is also noted that the term access system may be understood to refer to any access system configured for enabling wireless communication for user accessing applications.

The above described operations may require data processing in the various entities. The data processing may be provided by means of one or more data processors. Similarly various entities described in the above embodiments may be implemented within a single or a plurality of data processing entities and/or data processors. The data processing entities may be controlled by one or more computer programs which may be stored in one or more memories of the apparatus.

Alternatively or additionally appropriately adapted computer program code product may be used for implementing the embodiments, when loaded to a computer or a processor. The program code product for providing the operation may be stored on and provided by means of a carrier medium such as a carrier disc, card or tape. A possibility may be to download the program code product via a data network.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the inventions may be practiced in various components such as integrated circuit modules. The design of integrated circuits can be by and large a highly automated process. Complex and powerful software tools may be available for converting a logic level design into a semiconductor circuit design ready to be etched and formed on a semiconductor substrate.

Programs, such as those provided by Synopsys, Inc. of Mountain View, Calif. and Cadence Design, of San Jose, Califormia may automatically route conductors and locate components on a semiconductor chip using well established rules of design as well as libraries of pre-stored design modules. Once the design for a semiconductor circuit may have been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-35. (canceled)

36. A method comprising:
determining for a candidate component carrier for a cell if a gain obtained by said cell is better than a loss of a neighbouring cell using said candidate component carrier; and
if so, allocating said candidate component carrier to said cell.

37. The method as in claim 36, wherein said gain is a gain in capacity in said cell and said loss is a loss in capacity of a neighbouring cell.

38. The method as claimed in claim 36, wherein said determining step is such that said yield is greater than said loss by more than a threshold amount for said candidate component carrier to be allocated to said cell.

39. A computer program product comprising at least one non-transitory computer-readable storage medium having computer-executable program code instructions stored therein, the computer-executable program code instructions comprising:
program code instructions for determining a candidate component carrier for a cell if a gain obtained by said cell is better than a loss of a neighbouring cell using said candidate component carrier; and
if so, allocating said candidate component carrier to said cell.

40. An apparatus comprising:
at least one processor and at least one memory including computer program code, the at least one memory and computer program code configured to with the at least one processor cause the apparatus at least to:
determine for a candidate component carrier for a cell if a gain obtained by said cell is better than a loss of a neighbouring cell using said candidate component carrier; and
if so, allocate said candidate component carrier to said cell.

41. The apparatus as claimed in claim 40, wherein the at least one memory and computer program code are configured to with the at least one processor cause the apparatus to assume a power level for said candidate component carrier which is lower than a maximum power level and which is such that said gain is greater than said loss.

42. The apparatus as claimed in claim 40, wherein, the at least one memory and computer program code are configured to with the at least one processor cause the apparatus if it is determined that said gain is not greater than said loss, to repeat said determining assuming a lower power level associated with candidate component carrier.

43. The apparatus as claimed in claim 40, wherein said gain is a gain in capacity in said cell and said loss is a loss in capacity of a neighbouring cell.

44. The apparatus as claimed in claim 43, wherein said loss is defined as free capacity less a reduction in capacity due to use of the candidate component carrier; and wherein said free capacity comprises one of: a maximum throughput achievable without interference in said neighbouring cell; and a value based on a signal to interference noise ratio in said neighbouring cell.

45. The apparatus as claimed in claim 43, wherein said reduction in capacity is dependent on a signal to interference noise ratio in said prior cell assuming said candidate component carrier is allocated to said cell.

46. The apparatus as claimed in claim 43, wherein said gain is dependent on an incoming carrier to interference ratio towards said cell from said neighbouring cell.

47. The apparatus as claimed in claim 40, wherein said gain is a relative capacity gain of said cell if said component carrier is used with respect to the capacity of the cell before said candidate component carrier is used in said cell.

48. The apparatus as claimed in claim 40, wherein said loss is a relative capacity loss of said neighbouring cell if said component carrier is used in said cell with respect to the capacity of the neighbouring cell before the candidate component carrier is used in said cell.

49. The apparatus as claimed in claim 40, wherein said determining is such that said yield is greater than said loss by more than a threshold amount if said candidate component carrier is to be allocated to said cell.

50. The apparatus as claimed in claim 40, wherein the at least one memory and computer program code are configured to with the at least one processor cause the apparatus if said candidate component carrier is a base component carrier of said neighboring cell, to allocate said candidate component only if a predefined threshold is met.
